(19) United States
(12) Patent Application Publication
(10) Pub. No.: US 2009/0235088 A1
(43) Pub. Date: Sep. 17, 2009

(54) Program conversion device, execution support device, and method and computer program for the same

(76) Inventors: Haruaki Tamada, Nara (JP); Akito Monden, Nara (JP); Masahide Nakamura, Nara (JP); Kenichi Matsumoto, Nara (JP)

Correspondence Address: BIRCH STEWART KOLASCH & BIRCH, PO BOX 747, FALLS CHURCH, VA, 22040-0747, US

(21) Appl. No.: 11/921,908

(22) PCT Filed: Jun. 8, 2006
(86) PCT No.: PCT/JP2006/311504

§ 371 Date: Dec. 10, 2007

(30) Foreign Application Priority Data
Jun. 10, 2005 (JP) 2005-171372

(51) Int. Cl. G06F 21/22

(52) U.S. Cl. 713/190

(57) ABSTRACT

A method invocation modification unit modifies method invocation described in a body program to dynamic invocation and modifies the method invocation to invocation via an execution support device. An encryption unit modifies the body program by encrypting a character string designating the dynamic invocation after modification by the method invocation modification unit. Therefore, the method invocation can be hidden and understanding of the program can be made difficult.

### TECHNICAL FIELD

The present invention relates to a software protection technique, and more particularly to a program conversion device converting a given program to a program more difficult to analyze, an execution support device supporting execution of the converted program, and a method and a computer program for the same.

### BACKGROUND ART

Study on software protection has actively been conducted in recent years. Software protection collectively refers to techniques for protecting a software system against attacks such as tampering, analysis, copying, and reuse (illegal use) of software, and includes constituent technologies such as obfuscation, encryption, software diversity, electronic watermark, and birthmark.

Among these software protection techniques, from a viewpoint of invulnerability to attack, program obfuscation, which is a method of making a program itself difficult to analyze without an additional protection scheme, has particularly attracted attention.

Obfuscation is a technique for converting a given program to a more complicated program, and includes layout obfuscation, data obfuscation, control flow obfuscation, and the like. Though an obfuscated program has a function the same as the program before obfuscation, understanding or analysis thereof has been made more difficult. Examples of related techniques include: Japanese Patent Laying-Open No. 2005-49925 (Patent Document 1); Japanese Patent Laying-Open No. 2004-192068 (Patent Document 2); U.S. Pat. No. 6,102,966 (Patent Document 3); Toshio Ogiso and Yusuke Sakabe and Masakazu Soshi and Atsuko Miyaji, “Software obfuscation on a theoretical basis and its implementation,” IEICE Transactions on Fundamentals, Vol. E86-A, No. 1, pp. 176-186, January 2003 (Non-Patent Document 1); and Yusuke Sakabe and Masakazu Soshi and Atsuko Miyaji, “Java™ Obfuscation with a Theoretical Basis for Building Secure Mobile Agents,” Lecture Notes in Computer Science, Vol. 2828, pp. 89-103, 2003 (Non-Patent Document 2), as shown below.

Patent Document 1: Japanese Patent Laying-Open No. 2005-49925

Patent Document 2: Japanese Patent Laying-Open No. 2004-192068

Patent Document 3: U.S. Pat. No. 6,102,966

Non-Patent Document 1: Toshio Ogiso and Yusuke Sakabe and Masakazu Soshi and Atsuko Miyaji, “Software obfuscation on a theoretical basis and its implementation,” IEICE Transactions on Fundamentals, Vol. E86-A, No. 1, pp. 176-186, January 2003.

Non-Patent Document 2: Yusuke Sakabe and Masakazu Soshi and Atsuko Miyaji, “Java™ Obfuscation with a Theoretical Basis for Building Secure Mobile Agents,” Lecture Notes in Computer Science, Vol. 2828, pp. 89-103, 2003.

### DISCLOSURE OF THE INVENTION

### Problems to be Solved by the Invention

When a cracker analyzes, tampers or illegally uses a program, the cracker typically locates a name included in the program (a variable name, a function name, a class name, a method name, and the like) and understands the program, relying on the name. In order to prevent such an act, obfuscation by replacing a name that appears in the program with another very unintelligible name should be carried out.

On the other hand, static replacement of a name of a system API (Application Program Interface) used by the program or system definition such as a library function, a library class and a library method with another name is impossible. This is because system definition is given a fixed name (that cannot be changed), for allowing general-purpose use in a large number of computer environments.

Non-Patent Document 1 is directed to a technique for hiding method invocation processing, however, this technique cannot hide a name of a method group that may be invoked. Non-Patent Document 2 is directed to a technique for hiding a method to be invoked by allowing overload of methods in a class, however, this processing cannot be performed on invocation of a library method and hiding thereof is not successful. In addition, neither of a type of an argument and a type of a return value of an invoked method can be hidden. As the method to be invoked can be estimated from information relevant to the type of the argument or the like, a degree of obfuscation cannot be increased without hiding these types. Mere modification of the type, however, hinders execution of the obfuscated program, and therefore, it has been difficult to modify or erase the type.

Therefore, even with the techniques according to Patent Documents 1 to 3 or Non-Patent Documents 1 to 2 described above, it has been impossible to simultaneously achieve hiding of arbitrary method invocation, hiding of a name of an arbitrary module, and hiding of a type of an argument and a type of a return value of a module to be invoked, and it has namely been impossible to increase a degree of obfuscation of a program up to a certain level or higher.

The present invention was made to solve the above-described problems, and a first object is to provide a program conversion device for hiding processing of system definition included in a program and automatically converting the program to a program difficult to analyze, by encrypting in advance a class name, a method name and a field (variable) name and converting a type of a method to be invoked and a type of an argument, as well as a method and a computer program therefor.

A second object is to provide an execution support device capable of decrypting an encrypted name and carrying out dynamic method invocation and reference to a value in a field/assignment of a value to a field, in order to support execution of a body program that has been converted by the program conversion device and the like such that analysis thereof is made difficult, as well as a method and a computer program therefor.

### Means for Solving the Problems

According to one aspect of the present invention, a program conversion device for obfuscating a body program includes: an invocation modification unit modifying description of method invocation of the body program to description of dynamic invocation; and an encryption unit modifying the body program by encrypting a character string designating the dynamic invocation after modification by the invocation modification unit.

Preferably, the program conversion device further includes: a field modification unit modifying description referring to a field or description assigning a value to a field to description dynamically referring to a field or description dynamically assigning a value to a field; and the encryption unit modifying the body program by encrypting a name of the field included in description after modification by the field modification unit.

More preferably, the invocation modification unit makes modification such that the description of the dynamic invocation is invoked via a method in another class, and the field modification unit makes modification such that the description dynamically referring to the field or the description dynamically assigning the value to the field is carried out via the method in another class.

More preferably, the program conversion device further includes a variable type modification unit erasing a type of a variable included in the body program.

More preferably, the program conversion device further includes a key storage unit storing, in another class, a key for decrypting the character string encrypted by the encryption unit.

According to another aspect of the present invention, an execution support device supporting execution of an obfuscated body program includes: a decryption unit decrypting, in response to dynamic invocation of a method from the obfuscated body program, a character string from an encrypted value included in the invocation; and an execution unit executing the method using the character string decrypted by the decryption unit.

Preferably, the execution support device further includes: the decryption unit decrypting, in response to a request for dynamic reference to a field or dynamic assignment to a field from the obfuscated body program, a name of the field; and a field access unit carrying out reference to the field or assignment to the field by using the name decrypted by the decryption unit.

According to yet another aspect of the present invention, a program conversion method causing a computer to obfuscate a body program includes the steps of: modifying method invocation described in the body program to dynamic invocation; and modifying the body program by encrypting a character string designating the dynamic invocation after modification.

According to yet another aspect of the present invention, an execution support method causing a computer to support execution of an obfuscated body program includes the steps of: decrypting, in response to dynamic invocation of a method from the obfuscated body program, a character string from an encrypted value included in the invocation; and executing the method using the decrypted character string.

According to yet another aspect of the present invention, a computer program for causing a computer to perform a program conversion method for obfuscating a body program is provided, and the program conversion method includes the steps of: modifying method invocation described in the body program to dynamic invocation; and modifying the body program by encrypting a character string designating the dynamic invocation after modification.

According to yet another aspect of the present invention, a computer program causing a computer to perform an execution support method for supporting execution of an obfuscated body program is provided, and the execution support method includes the steps of: decrypting, in response to dynamic invocation of a method from the obfuscated body program, a character string from an encrypted value included in the invocation; and executing the method using the decrypted character string.

### EFFECTS OF THE INVENTION

According to one aspect of the present invention, modification is made such that method invocation in the body program is dynamically carried out, and thereafter the name of the method designated in dynamic invocation is encrypted. Therefore, which method is invoked can be hidden and understanding of the program can be made difficult.

In addition, modification is made such that description of reference/assignment to the field in the body program is carried out via a method in another class, and thereafter the name of the field is handled with the name thereof being encrypted. Therefore, to which field reference or assignment is made can be hidden and understanding of the program can be made difficult.

Moreover, as the variable type modification unit modifies the type of the variable included in the body program, information on types of all variables that appear in the program, such as a type of an argument or a return value, can be hidden and understanding of the program can further be made difficult.

Further, as the invocation modification unit and the field modification unit make modification such that invocation modified to be dynamic or description of reference to the field or assignment to the field is carried out via a method in another class, another class can support execution of the obfuscated body program.

According to another aspect of the present invention, the decryption unit decrypts, in response to method invocation from the obfuscated body program, the character string from the encrypted value included in the invocation, and the execution unit executes the method using the decrypted character string. Thus, execution of the body program obfuscated by the program conversion device or the like can be supported.

In addition, the decryption unit decrypts the name of the field in response to a request for reference to the field or assignment to the field from the obfuscated body program, and the field access unit refers to the field or carries out assignment to the field by using the decrypted name. Thus, support in execution of the body program converted by the program conversion device or the like can further be facilitated.

### BRIEF DESCRIPTION OF THE DRAWINGS

FIG. 1 is a block diagram showing a configuration example of a program conversion device and an execution support device in an embodiment of the present invention.

FIG. 2 is a block diagram showing a functional configuration of the program conversion device in the embodiment of the present invention.

FIG. 3 is a flowchart for illustrating a processing procedure of a program conversion device 21 in the embodiment of the present invention.

FIG. 4 illustrates a body program 100 before conversion and a body program 200 after modification of method invocation.

FIG. 5 illustrates program 100 before conversion and a body program 300 after modification of reference to a value in a field/assignment of a value to a field.

FIG. 6 illustrates body program 100 before conversion and a body program 400 after modification of a type of a variable to object class.

FIG. 7 illustrates body program 100 before conversion and a body program 500 after modification to an encrypted name.

FIG. 8 is a block diagram showing a functional configuration of an execution support device 22 in the embodiment of the present invention.

### DESCRIPTION OF THE REFERENCE SIGNS

1 computer main unit; 2 display device; 3 FD drive; 4 FD; 5 keyboard; 6 mouse; 7 CD-ROM device; 8 CD-ROM; 9 network communication device; 10 CPU; 11 ROM; 12 RAM; 13 hard disk; 21 program conversion device; 22 execution support device; 23 body program; 24 body program after conversion; 31 access restriction modification unit; 32 method invocation modification unit; 33 field reference/assignment modification unit; 34 variable type modification unit; 35 encryption unit; 36 character string storage unit; 41 instance generation unit; 42 method execution unit; 43 field reference unit; 44 field assignment unit; and 45 decryption unit.

### BEST MODES FOR CARRYING OUT THE INVENTION

A program conversion device in the embodiment of the present invention converts an original program to a program utilizing dynamic invocation, such that method invocation and reference/assignment to a field in a program described in an object-oriented language such as Java™ are hidden and a type of a variable is modified. Then, an execution support device interprets invocation or the like of the converted program and executes the method. The execution support device is provided as a class that supports execution of a body program such as dynamic invocation, and hereinafter also referred to as DynamicCaller class. In addition, an embodiment in which a method in another class, modification to which is made so that invocation or the like is made via the same, serves as the execution support device in the program conversion device is also possible.

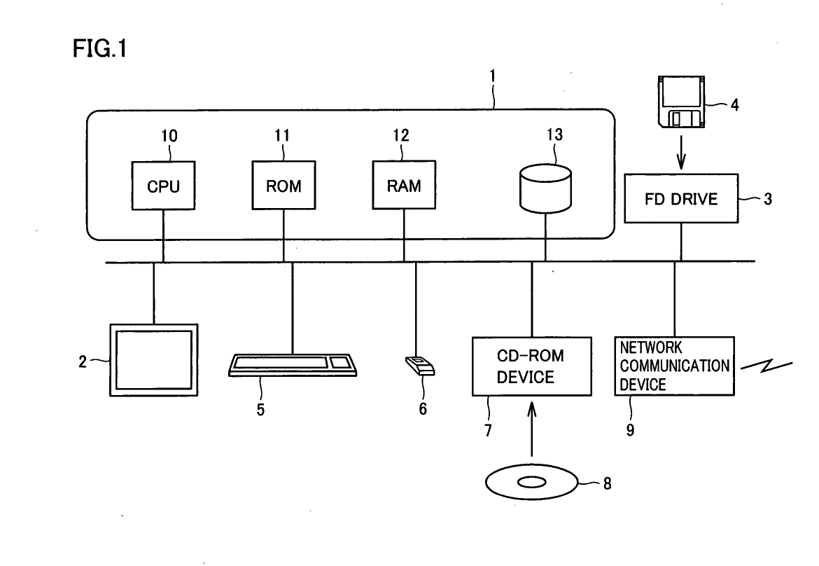

FIG. 1 is a block diagram showing a configuration example of the program conversion device and the execution support device in the embodiment of the present invention. The program conversion device and the execution support device include a computer main unit 1, a display device 2, an FD (Flexible Disk) drive 3 on which an FD 4 is mounted, a keyboard 5, a mouse 6, a CD-ROM (Compact Disc-Read Only Memory) device 7 on which a CD-ROM 8 is mounted, and a network communication device 9 connected to a network. A program conversion program and an execution support program are supplied by a recording medium such as FD 4 or CD-ROM 8. Execution of the program conversion program and the execution support program by computer main unit 1 enables control of the entire program conversion device and execution support device. Alternatively, the program conversion program and the execution support program may be supplied to computer main unit 1 from another computer through a communication line.

Computer main unit 1 shown in FIG. 1 includes a CPU (Central Processing Unit) 10, an ROM (Read Only Memory) 11, an RAM (Random Access Memory) 12, and a hard disk 13. CPU 10 performs processing while inputting/outputting data among display device 2, FD drive 3, keyboard 5, mouse 6, CD-ROM device 7, network communication device 9, ROM 11, RAM 12, and hard disk 13. The program conversion program and the execution support program recorded in FD 4 or CD-ROM 8 are stored in hard disk 13 via FD drive 3 or CD-ROM device 7 by means of CPU 10. CPU 10 controls the entire program conversion device and execution support device by loading as appropriate the program conversion program and the execution support program from hard disk 13 to RAM 12 and executing the same.

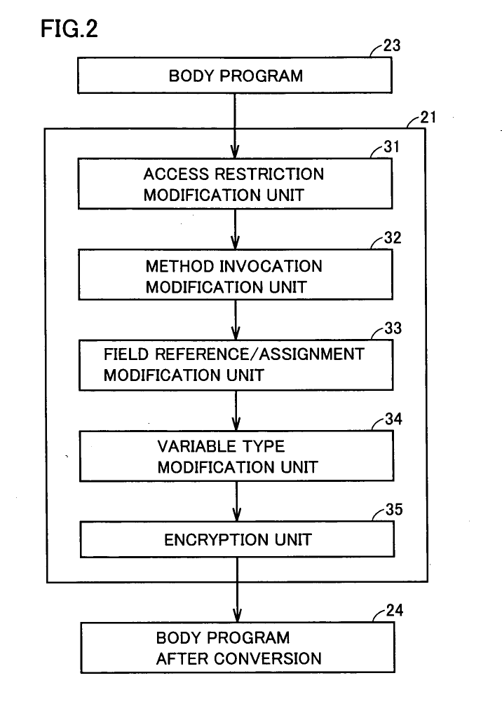

FIG. 2 is a block diagram showing a functional configuration of the program conversion device in the embodiment of the present invention. A program conversion device 21 includes an access restriction modification unit 31 modifying access restriction described in a body program 23, a method invocation modification unit 32 making modification such that a method present in body program 23 is invoked via DynamicCaller class 22, a field reference/assignment modification unit 33 making modification such that description of reference to a value in a field/assignment of a value to a field present in body program 23 (get/set) is carried out via DynamicCaller class 22, a variable type modification unit 34 modifying the field and a type of a local variable present in body program 23 to Object class, and an encryption unit 35 encrypting a character string such as a class name, a method name and a field name to an encrypted name.

An access modifier is present for a member (a field and a method) in a class of the object-oriented language. The access modifier defines an allowable range of access to a field or a method, and includes public, protected and private. Access restriction modification unit 31 sets all access modifiers for members in the class to public. As all methods are thus invoked via DynamicCaller class, DynamicCaller class can access to any member in the class.

In general, the program described in the object-oriented language operates by creating an object by creating an instance of the class, and by sending a message to that object. Definition of the class can dynamically be modified during execution of the program by using a metaclass. In the embodiment of the present invention, such dynamic invocation is utilized.

For example, in a case of Java™ language, java™.lang.Class class corresponds to a metaclass, and an instance of Class class can be obtained by giving a character string indicating a class name to a forName static method in Class class. Then, a newInstance method is executed with respect to the obtained instance of Class class, so that an object of the corresponding class can be generated. In addition, by obtaining a java™.lang.reflect.Method object from an instance of Class class, a method to be executed can be determined from the given character string. Dynamic invocation of the method can thus be carried out.

Method invocation unit 32 modifies body program 23 by using such a metaclass, such that a process from generation of an object to execution of a method is performed by giving a character string.

In addition, in the embodiment of the present invention, polymorphism representing one important characteristic of object-oriented is used to make program analysis more difficult. Polymorphism means that objects different in class operate differently with respect to the same message. Specifically, if objects different in class are present in the same type of variables, an operation may be different depending on an object present in the variable and a result of execution may be different.

In the embodiment of the present invention, a metaclass is obtained from an object, definition of a method or a field is obtained from that metaclass, and thereafter processing of these is performed. Therefore, if the object present in the variable is the same as that before program conversion (before obfuscation) even though the type information is hidden, an operation of the body program is not affected. Here, variable type modification unit 34 modifies the type of the member in the class to a root class in a class hierarchy, so that the type information of the body program is erased and analysis of the program can be made more difficult.

Encryption unit 35 encrypts a character string such as a class name and a method name modified by method invocation modification unit 32 and field reference/assignment modification unit 33, for modification to an encrypted name. Encryption unit 35 may be divided into a first encryption unit encrypting a method name modified by method invocation modification unit 32 and a second encryption unit encrypting a field name modified by field reference/assignment modification unit 33. In the present embodiment, though a common key encryption is employed as an encryption system, symmetric key encryption or a hash function may be employed for encryption. Where the common key encryption system and the symmetric key encryption system are employed, a decryption key should be stored in the program conversion device or the execution support device. Where the hash function is employed, decryption of a character string before hashing should be enabled, by storing a table containing the character string before hashing in execution support device 22.

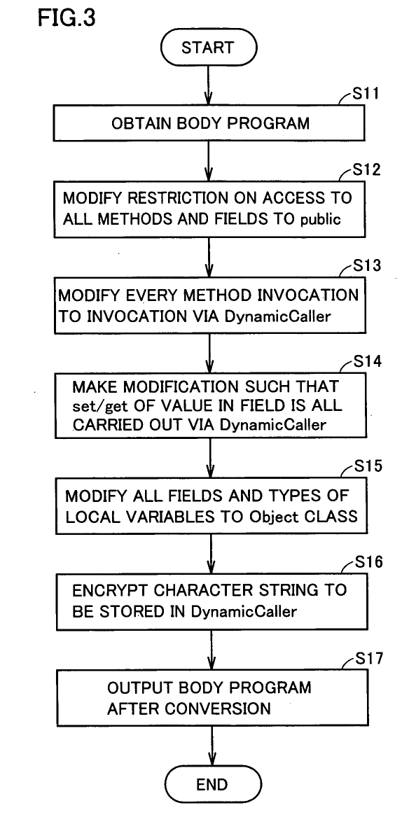

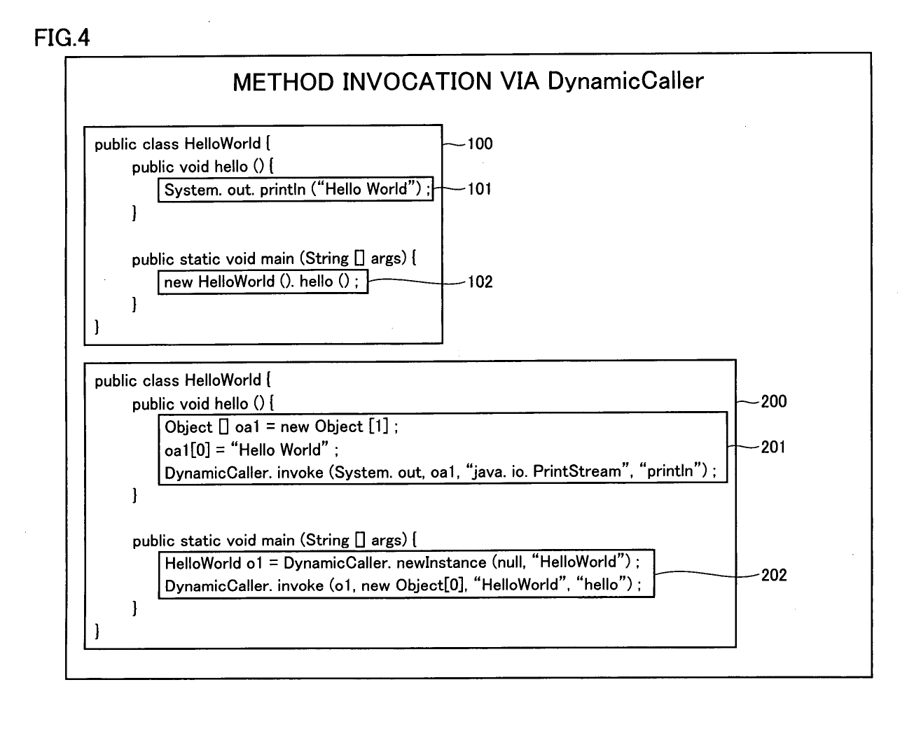

FIG. 3 is a flowchart for illustrating a processing procedure of program conversion device 21 in the embodiment of the present invention. The processing procedure of program conversion device 21 will be described with reference to the flowchart shown in FIG. 3 and program conversion examples shown in FIGS. 4 to 7.

Initially, access restriction modification unit 31 obtains body program 23 (S11) and modifies restriction on access to all methods and fields to public (S12). Body program 100 before conversion shown in FIGS. 4 to 7 represents a program after modification of access restriction to public.

Thereafter, method invocation modification unit 32 modifies every method invocation to invocation via DynamicCaller class 22 (S13). In the embodiment of the present invention, dynamic invocation may be carried out without using a method in another class, that is, DynamicCaller class. Here, a processing function of DynamicCaller should be implemented by the body program.

FIG. 4 illustrates body program 100 before conversion and a body program 200 after modification of method invocation. The program defines and executes HelloWorld class, and method invocation modification unit 32 has modified description 101 and description 102 of body program 100 before conversion to description 201 and description 202 of body program 200 after modification, respectively. As shown in description 201, “HelloWorld” is assigned to a variable oa1 as a new object, and modification is made such that printIn method in java™.io.PrintStream class is invoked via DynamicCaller class. Java™.io.PrintStream is a character string designated at the time of execution of a method by using the metaclass described above. Dynamic invocation is carried out using this character string.

In addition, as shown in description 202, by executing a newInstance method via DynamicCaller class 22, an instance of HelloWorld class is generated and the generated instance is assigned to a variable o1. Then, a hello method in HelloWorld class is invoked via DynamicCaller class 22. Here, an instance for invoking the method is variable o1.

Thereafter, field reference/assignment modification unit 33 makes modification such that reference to a value in the field/assignment of a value to the field present in body program 23 (get/set) is all carried out via DynamicCaller 22 (S14).

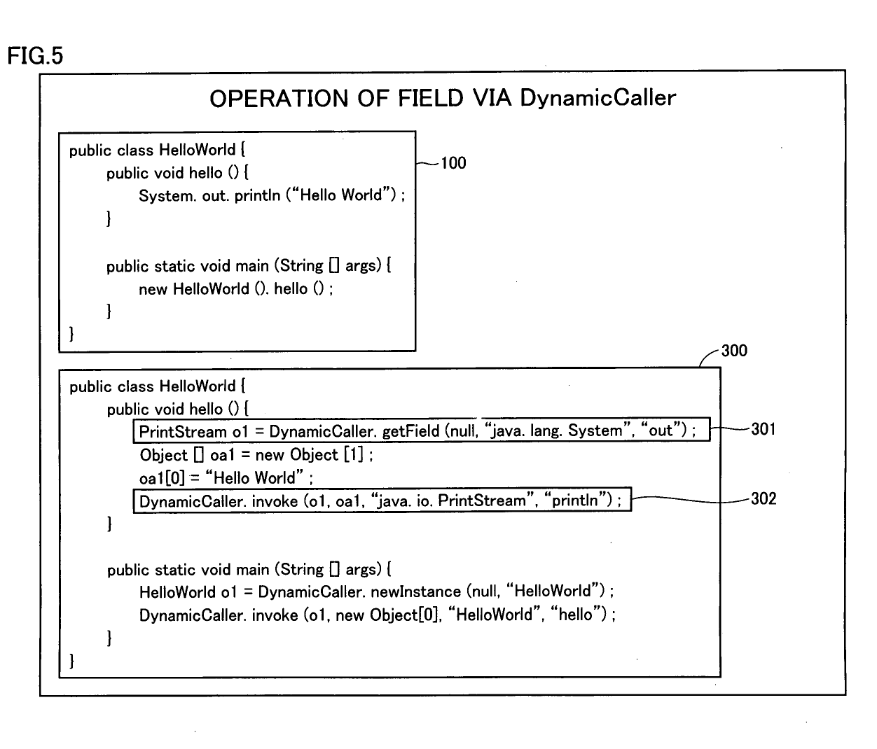

FIG. 5 illustrates program 100 before conversion and a body program 300 after modification of reference to a value in a field/assignment of a value to a field. Field reference/assignment modification unit 33 has modified the last line in description 201 shown in FIG. 4 to description 301 and description 302 shown in FIG. 5. As shown in description 302 in FIG. 5, System.out in the last line in description 201 in FIG. 4 is replaced with variable o1. In addition, description 301 in FIG. 5 is added, and a value in an out field in java™.lang.System class is referred to via DynamicCaller class 22 and assigned to variable o1.

Thereafter, variable type modification unit 34 modifies all fields and types of local variables to Object class, which is the root class in the class hierarchy (S15).

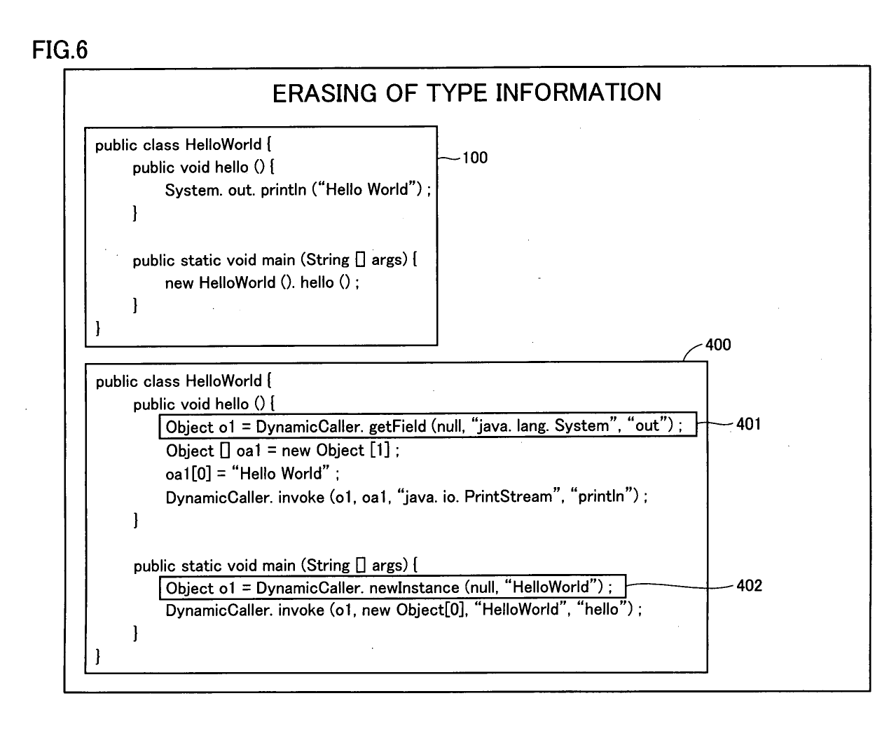

FIG. 6 illustrates body program 100 before conversion and a body program 400 after modification of a type of a variable to Object class. Variable type modification unit 34 has modified description 301 shown in FIG. 5 and the first line in description 202 shown in FIG. 4 to description 401 and description 402 shown in FIG. 6, respectively. As shown in description 401 in FIG. 6, the type of variable o1, that had been PrintStream, has been modified to Object class. In addition, as shown in description 402 in FIG. 6, the type of variable o1, that had been HelloWorld, has been modified to Object class.

Thereafter, encryption unit 35 modifies a name within body program 23 to an encrypted name, by encrypting a class name, a method name and the like (S16).

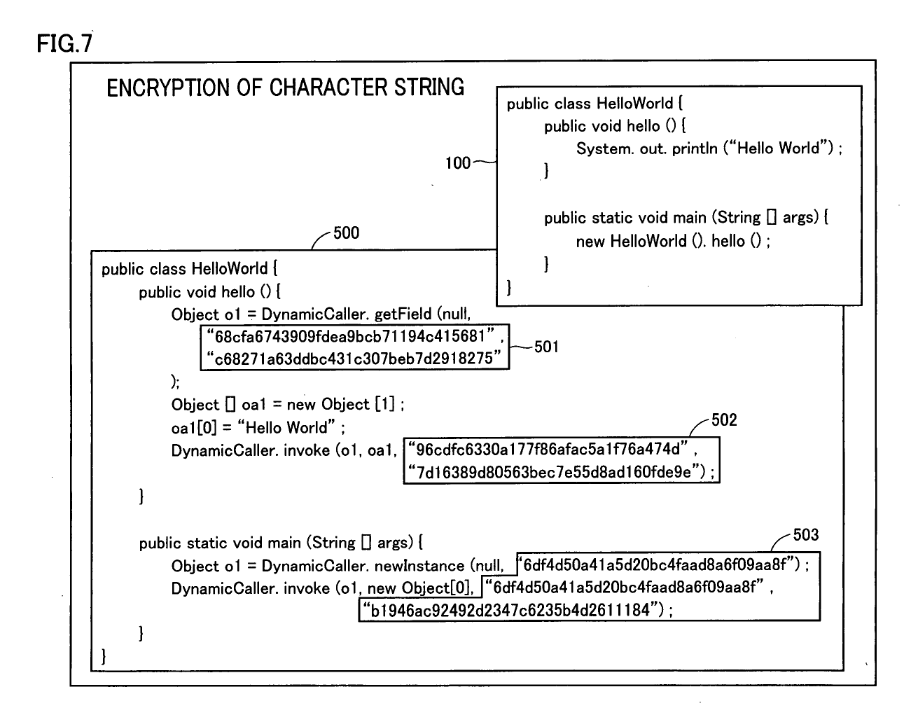

FIG. 7 illustrates body program 100 before conversion and a body program 500 after modification to the encrypted name. As seen in FIG. 7, encryption unit 35 encrypts the class name, the field name and the method name to names as shown in descriptions 501 to 503. Description 501 in FIG. 7 includes modified version of the class name java™.lang.System and modified version of the field name out, description 502 includes modified version of the class name java™.io.PrintStream and modified version of the method name printIn, and description 503 includes modified version of the class name HelloWorld and modified version of the method name hello.

Thereafter, encryption unit 35 outputs a body program after conversion 24 as shown in FIG. 7 (S17) and ends the processing.

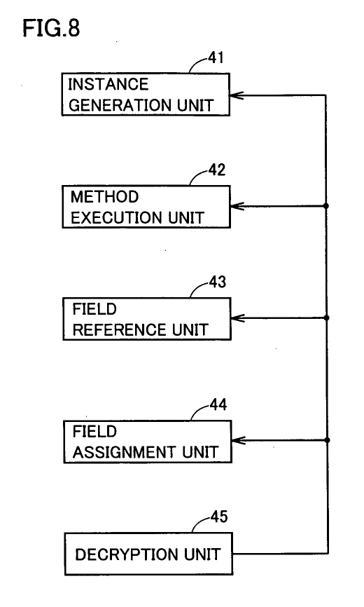

FIG. 8 is a block diagram showing a functional configuration of execution support device 22 in the embodiment of the present invention. Execution support device 22 operates in response to invocation from body program after conversion 24 when body program 24 after conversion by program conversion device 21 is executed, and includes an instance generation unit 41, a method execution unit 42, a field reference unit 43, a field assignment unit 44, and a decryption unit 45. It is noted that each of instance generation unit 41, method execution unit 42, field reference unit 43, and field assignment unit 44 is provided as a method. The decryption unit stores in advance a decryption key corresponding to an encryption key used in the encryption unit. If encryption is carried out using a hash function, a name (character string) before hashing should be stored in the decryption unit at the time of encryption in the program conversion device. Instance generation unit 41, method execution unit 42, field reference unit 43, and field assignment unit 44 in the execution support device may all be encompassed in DynamicCaller class 22.

Instance generation unit 41 generates an instance of a target class from a metaclass, in response to a request from body program after conversion 24. Namely, instance generation unit 41 extracts an encrypted value included in the request from body program after conversion 24, and decryption unit 45 decrypts the value so as to obtain the name before encryption. Then, instance generation unit 41 generates an instance based on the name before encryption, and returns the generated instance to body program after conversion 24.

Method execution unit 42 refers to the metaclass in response to invocation from body program after conversion 24 and executes the designated method in the target class. Namely, method execution unit 42 extracts the encrypted value included in the invocation from body program after conversion 24, and decryption unit 45 decrypts the value so as to obtain the name before encryption. Then, method execution unit 42 executes the method based on the name before encryption, and returns the return value of the executed method to body program after conversion 24.

Field reference unit 43 refers to the metaclass in response to the request from body program after conversion 24 and refers to the designated field in the target class. Namely, field reference unit 43 extracts the encrypted value included in the request from body program after conversion 24, and decryption unit 45 decrypts the value so as to obtain the name before encryption. Then, field reference unit 43 refers to the value in the field stored in standard library based on the name before encryption and returns the value in the field to body program after conversion 24.

Field assignment unit 44 refers to the metaclass in response to the request from body program after conversion 24 and assigns a value to the designated field in the target class. Namely, field assignment unit 44 extracts the encrypted value included in the request from body program after conversion 24, and decryption unit 45 decrypts the value so as to obtain the name before encryption. Then, field assignment unit 44 assigns the value to the field stored in standard library or the like based on the name before encryption. It is noted that field assignment unit 44 returns nothing to body program after conversion 24.

As described above, according to the program conversion device in the present embodiment, method invocation in all classes is converted to dynamic invocation and the character string used for dynamic invocation is encrypted. Therefore, method invocation present in the body program can be hidden and understanding of the program can be made difficult.

In addition, as the field name used when the value in the field is referred to/the value is assigned to the field is encrypted, access to the field can be hidden and understanding of the program can be made more difficult.

Moreover, as the types of variables (type of argument and type of return value) are all modified to the root class in the class hierarchy, the type of the variable can be hidden and understanding of the program can be made more difficult.

According to the execution support device in the present embodiment, decryption unit 45 obtains an original name of an encrypted name, and the obtained original name is used to carry out generation of an instance, execution of a method, reference to a field, and assignment to the field. Therefore, execution of body program after conversion 24 by the program conversion device can be supported.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

1. A program conversion device for obfuscating a body program, comprising:
an invocation modification unit modifying description of method invocation of said body program to description of dynamic invocation; and
an encryption unit modifying said body program by encrypting a character string designating the dynamic invocation after modification by said invocation modification unit.

2. The program conversion device according to claim 1, further comprising:
a field modification unit modifying description referring to a field or description assigning a value to a field to description dynamically referring to a field or description dynamically assigning a value to a field; and
the encryption unit modifying said body program by encrypting a name of the field included in the description after modification by said field modification unit.

3. The program conversion device according to claim 2, wherein
said invocation modification unit makes modification such that the description of said dynamic invocation is invoked via a method in another class, and
said field modification unit makes modification such that the description dynamically referring to the field or the description dynamically assigning the value to the field is carried out via said method in another class.

4. The program conversion device according to claim 1, further comprising a variable type modification unit erasing a type of a variable included in said body program.

5. An execution support device supporting execution of an obfuscated body program, comprising:
a decryption unit decrypting a character string from an encrypted value in response to dynamic invocation of a method from said obfuscated body program; and
an execution unit executing the method using the character string decrypted by said decryption unit.

6. The execution support device according to claim 5, further comprising:
the decryption unit decrypting, in response to a request for dynamic reference to a field or dynamic assignment to a field from said obfuscated body program, a name of said field; and
a field access unit carrying out dynamic reference to the field or dynamic assignment to the field by using the name decrypted by said decryption unit.

7. A program conversion method causing a computer to obfuscate a body program, comprising the steps of:
modifying description of method invocation of said body program to description of dynamic invocation; and
modifying said body program by encrypting a character string designating the dynamic invocation after modification.

8. An execution support method causing a computer to support execution of an obfuscated body program, comprising the steps of:
decrypting, in response to dynamic invocation of a method from said obfuscated body program, a character string from an encrypted value included in said invocation; and
executing the method using said decrypted character string.

9. A computer program for causing a computer to perform a program conversion method for obfuscating a body program, said program conversion method including the steps of
modifying description of method invocation of said body program to description of dynamic invocation, and
modifying said body program by encrypting a character string designating the dynamic invocation after modification.

10. A computer program causing a computer to perform an execution support method for supporting execution of an obfuscated body program, said execution support method including the steps of
decrypting, in response to dynamic invocation of a method from said obfuscated body program, a character string from an encrypted value included in said invocation, and
executing the method using said decrypted character string.

11. The program conversion device according to claim 2, further comprising a variable type modification unit erasing a type of a variable included in said body program.

12. The program conversion device according to claim 3, further comprising a variable type modification unit erasing a type of a variable included in said body program.
